(19) United States
(12) Patent Application Publication
(10) Pub. No.: US 2001/0011947 A1
(43) Pub. Date: Aug. 9, 2001

(54) SYSTEM AND METHOD FOR SECURING A COMPUTER SYSTEM

(76) Inventors: MUHAMMED JABER, ROUND ROCK, TX (US); JAMES E. DAILEY, ROUND ROCK, TX (US)

Correspondence Address: DAVID L MCCOMBS, HAYNES AND BOONE LLP, 3100 NATIONS BANK PLAZA, 901 MAIN STREET, DALLAS, TX, 752023789

(21) Appl. No.: 09/317,233

(22) Filed: May 24, 1999

(51) Int. Cl. G08B 13/14

(52) U.S. Cl. 340/568.1; 340/568.2; 340/568.3; 340/568.4; 340/571

(57) ABSTRACT

A computer system includes circuitry for detecting whether it becomes disconnected from an object, which may include an AC power source. In response to the computer system becoming disconnected from the object, it determines whether the disconnection is authorized, which may include determining whether a valid password has been output to the computer system. In response to the disconnection being unauthorized, an alarm action is initiated.

### BACKGROUND

The disclosures herein relate in general to information processing systems and in particular to a system and method for securing operation of a computer system.

In comparison to a desktop computer, a portable computer is more subject to theft under some circumstances. Accordingly, various security features have been developed to deter such theft. At least some of those features are mechanical.

According to one technique, a mechanical security device (e.g. a hook latch protrusion) mechanically secures (e.g. holds) the portable computer to a docking station. Nevertheless, such a technique has at least one shortcoming. For example, the mechanical security device is subject to defeat by mechanically prying the portable computer loose from the docking station. With such a technique, the portable computer's security is dependent on increased strength of a material, such as plastic or metal, that houses components of the portable computer or docking station. Nevertheless, practical limits (on the extent to which the material's strength may be increased) are imposed by factors such as cost, weight, and convenient use.

Accordingly, a need has arisen for a system and method for securing a computer system, in which various shortcomings of previous techniques are overcome. More particularly, a need has arisen for a system and method for securing a computer system, in which the computer system's security is less dependent on mechanical security features.

### SUMMARY

One embodiment, accordingly, provides for a computer system that detects whether it becomes disconnected from an object. In response to the computer system becoming disconnected from the object, it determines whether the disconnection is authorized. In response to the disconnection being unauthorized, an alarm action is initiated.

A principal advantage of this embodiment is that (a) various shortcomings of previous techniques are overcome, and (b) the computer system's security is less dependent on mechanical security features.

### BRIEF DESCRIPTION OF THE DRAWING FIGURES

FIG. 1 is a block diagram of a computer system according to the illustrative embodiment.

FIG. 2 is a block diagram of a computer of the computer system of FIG. 1.

FIG. 3 is a first perspective view of a portable embodiment of the computer system of FIG. 1.

FIG. 4 is a perspective view of a docking station as it secures the portable embodiment of FIG. 3.

FIG. 5 is a state diagram of operation of the computer of FIG. 2 in securing the computer system of FIG. 1.

FIG. 6 is a flowchart of operation of the computer of FIG. 2 in a normal state of FIG. 5.

FIG. 7 is a flowchart of operation of the computer of FIG. 2 in a watching state of FIG. 5.

FIG. 8 is a flowchart of operation of the computer of FIG. 2 in an alarm state of FIG. 5.

FIG. 9 is a flowchart of operation of the computer of FIG. 2 in a disabled state of FIG. 5.

### DETAILED DESCRIPTION

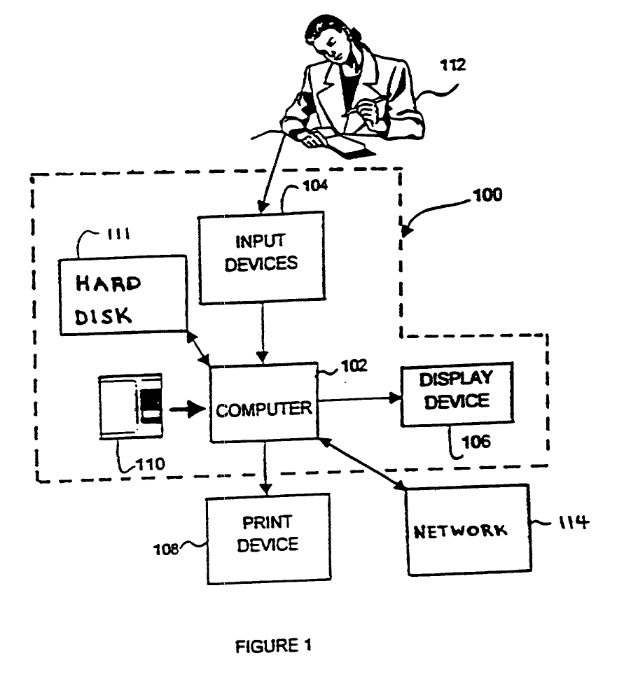

FIG. 1 is a block diagram of a computer system, indicated generally at 100, according to the illustrative embodiment. System 100 includes input devices 104, a display device 106, and a computer 102 for executing processes and performing operations (e.g. communicating information) in response thereto as discussed further hereinbelow. In the illustrative embodiment, system 100 is an IBM-compatible portable personal computer (“PC”) that executes Microsoft Windows 95 operating system (“OS”) software. All Microsoft products identified herein are available from Microsoft Corporation, One Microsoft Way, Redmond, Wash. 98052-6399, telephone (425) 882-8080.

Computer 102 is connected to input devices 104, display device 106 and a print device 108. Print device 108 is, for example, a conventional electronic printer or plotter. Also, computer 102 includes internal speakers for outputting audio signals. In an alternative embodiment, the speakers are external to computer 102. Moreover, system 100 includes (a) a first computer-readable medium (or apparatus) 110 which is a floppy diskette and (b) a second computer-readable medium (or apparatus) 111 which is a computer hard disk.

A human user 112 and computer 102 operate in association with one another. For example, in response to signals from computer 102, display device 106 displays visual images, and user 112 views such visual images. Also, in response to signals from computer 102, print device 108 prints visual images on paper, and user 112 views such visual images. Further, user 112 operates input devices 104 in order to output information to computer 102, and computer 102 receives such information from input devices 104.

Input devices 104 include, for example, a conventional electronic keyboard and a pointing device such as a conventional electronic “mouse”, rollerball or light pen. User 112 operates the keyboard to output alphanumeric text information to computer 102, and computer 102 receives such alphanumeric text information from the keyboard. User 112 operates the pointing device to output cursor-control information to computer 102, and computer 102 receives such cursor-control information from the pointing device.

A network 114 includes a network local area network (“LAN”) control manager server computer (“LCM”). For communicating with (i.e. outputting information to, and receiving information from) network 114 (including the LCM), computer 102 includes a network interface card (“NIC”) which is yet another type of computer-readable medium (or apparatus) connected to computer 102.

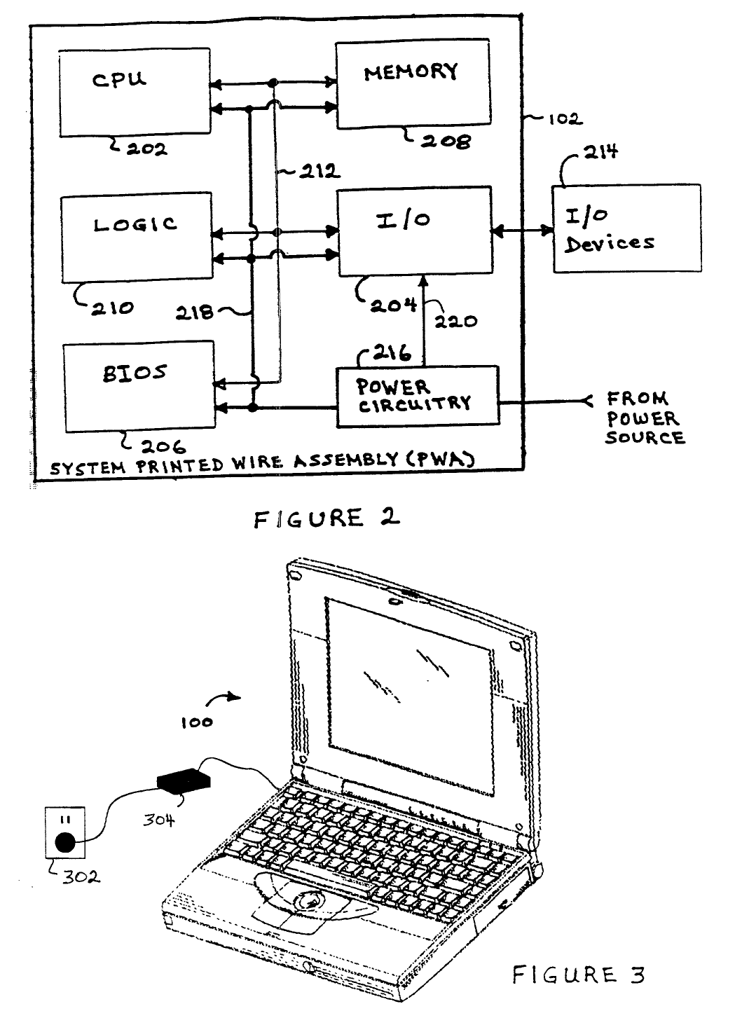

FIG. 2 is a block diagram of computer 102, which is formed by various electronic circuitry components. In the example of FIG. 2, such electronic circuitry components reside on a system printed wire assembly (“PWA”). As shown in FIG. 2, the electronic circuitry components of computer 102 include: a central processing unit (“CPU”) 202 for executing and otherwise processing instructions, input/output (“I/O”) controller circuitry 204, a basic input/output system (“BIOS”) electrically erasable programmable read only memory device (“EEPROM”) 206 for storing firmware, a memory 208 such as random access memory device (“RAM”) and read only memory device (“ROM”) for storing information (e.g. instructions executed by CPU 202 and data operated upon by CPU 202 in response to such instructions), and other miscellaneous electronic circuitry logic 210 for performing other operations of computer 102, all coupled to one another through one or more buses 212. Also, computer 102 may include various other electronic circuitry components that, for clarity, are not shown in FIG. 2.

As shown in FIG. 2, I/O controller circuitry 210 is coupled to I/O devices 216. I/O devices 216 include, for example, input devices 104, display device 106, print device 108, floppy diskette 110, hard disk 111, and the network interface card (“NIC”) discussed hereinabove in connection with FIG. 1. I/O controller circuitry 210 includes controller circuitry for operating I/O devices 216, reading information from I/O devices 216, and writing information to I/O devices 216.

Computer 102 operates its various components (e.g. I/O controller circuitry 210) in response to information stored by BIOS 206 (which is a computer-readable medium, as discussed hereinabove in connection with FIG. 1). For example, I/O controller circuitry 210 outputs various interrupt requests (“IRQs”), and computer 102 reacts to such IRQs in response to information stored by BIOS 206. Accordingly, by suitably modifying information stored by BIOS 206, one or more components of computer 102 may be effectively disabled, so that computer 102 operates without reference to such components. In such a situation where a component is disabled, computer 102 would not react to an IRQ from such a disabled component, and computer 102 would not allocate resources to such a disabled component.

Also, computer 102 includes power circuitry 216 coupled through a power bus 218 to each of CPU 202, I/O controller circuitry 204, BIOS 206, memory 208 and logic 210. Power circuitry 216 receives power from a power source (e.g. direct current (“DC”) source such as a battery, or alternating current (“AC”) source), converts such power into a suitable form, and distributes such converted power through power bus 218. Accordingly, power circuitry 216 includes circuitry such as pull-up resistors. In a significant aspect of the illustrative embodiment, power circuitry 216 is further connected to I/O controller circuitry 204 through an electrically conductive signal line 220.

FIG. 3 is a first perspective view of a portable embodiment of system 100. In the illustrative embodiment, the portable embodiment of system 100 is a laptop computer or notebook computer. In an alternative embodiment, the portable embodiment of system 100 is a palmtop computer device or other handheld computer system.

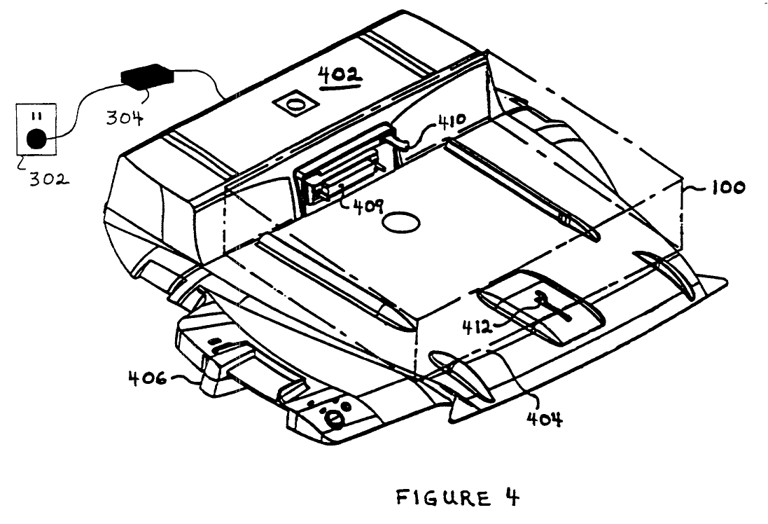

As shown in FIG. 3, system 100 receives power from an AC source 302, such as a conventional wall electrical outlet, via a conventional AC/DC converter 304 that is connected to power circuitry 216 (FIG. 2) of computer 102. A rear portion of the portable embodiment includes receptacles for mechanically engaging with a docking station, as discussed further hereinbelow in connection with FIG. 4.

FIG. 4 is a perspective view of a docking station 402 device as it secures the portable embodiment of system 100. Docking station 402 includes a surface 404 for supporting the portable embodiment of system 100, as shown in FIG. 4. A handle 406 of docking station 402 is operable by user 112 and is movable between an eject position, an unlock position, and a lock position.

Docking station 402 includes a bus connector 409 for mechanically engaging with a receptacle at the rear portion of system 100, in order to electrically connect docking station 402 to system 100 and thereby enable communication of information between them. Also, docking station 402 includes a first security device 410 having a hook latch protrusion that is selectively movable into and out of mechanical engagement with a receptacle at the rear portion of system 100, in order to mechanically secure system 100 to docking station 402. Likewise, docking station 402 includes a second security device 412 having a hook latch protrusion that is selectively movable into and out of mechanical engagement with a bottom receptacle of system 100, in order to mechanically secure system 100 to docking station 402. In the disclosures herein, all references to engaging (or engagement of) A with B are likewise intended to mean engaging (or engagement of) B with A, so that such engaging (or engagement) is of A and B with one another (i.e. engaging (or engagement) between A and B).

The hook latch protrusions of security devices 410 and 412 are selectively movable in response to a movement of handle 406 between the eject position, the unlock position, and the lock position. In operation, system 100 is seated on docking station 402 with handle 406 in the unlock position. When system 100 is to be mechanically secured to docking station 402, user 112 operates handle 406 by moving it to the lock position. In response to such an operation, the hook latch protrusions of security devices 410 and 412 move into mechanical engagement with system 100. During such engagement between docking station 402 and system 100, physical disconnection of system 100 from docking station 402 (e.g. physical removal of system 100 away from docking station 402) involves physically breaking system 100 by application of a predetermined physical force on system 100.

When system 100 is to be removed from docking station 402, user 112 operates handle 406 by moving it to the eject position, and handle 406 subsequently returns to the unlock position. In response to such operation, the hook latch protrusions of security devices 410 and 412 move out of mechanical engagement with (i.e. mechanically disengage from) system 100, in order to mechanically release system 100 from docking station 402.

As shown in FIG. 4, system 100 receives power from AC source 302 via conventional AC/DC converter 304 that is connected through docking station 402 (and connector 409) to power circuitry 216 (FIG. 2) of computer 102. In a significant aspect of the illustrative embodiment, the programming of BIOS 206 and the design of I/O controller circuitry 204 are suitable to detect a removal of power from power circuitry 216, as for example if power circuitry 216 becomes disconnected from the power source or if the power source is turned off.

Notably, in response to a removal of AC power (from AC source 302) from power circuitry 216, power circuitry 216 automatically switches to receive power from a battery of system 100 instead of AC source 302. Nevertheless, in such a situation, even in automatically switching to receive power from such a battery, the programming of BIOS 206 and the design of I/O controller circuitry 204 are suitable to detect the removal of AC power from power circuitry 216. This is true irrespective of whether power circuitry 216 receives the AC power from AC source 302 in the manner shown in FIG. 3 or alternatively in FIG. 4.

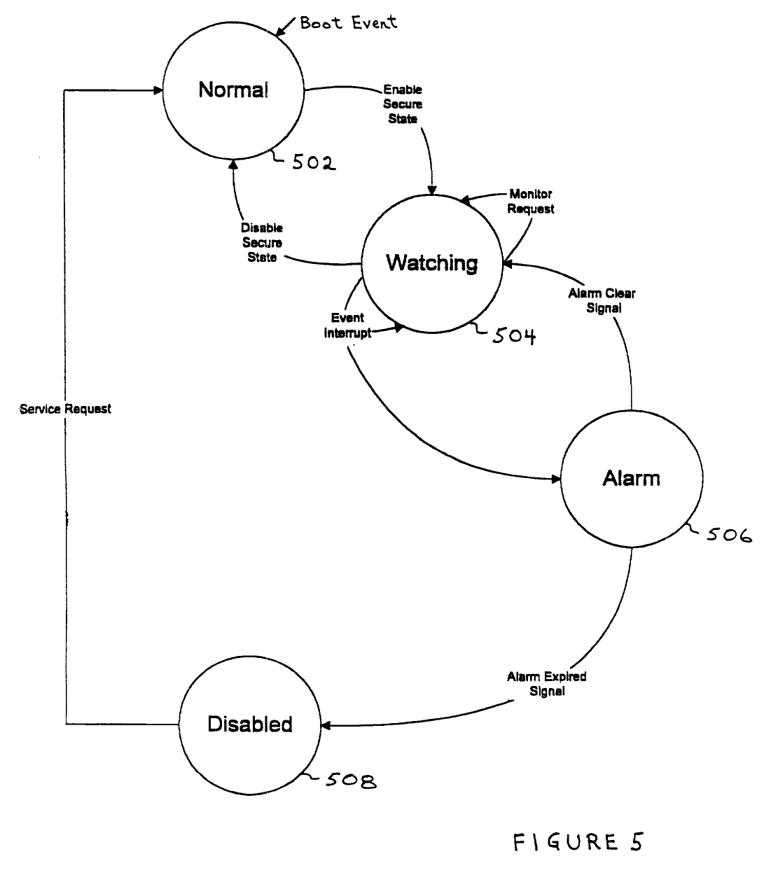

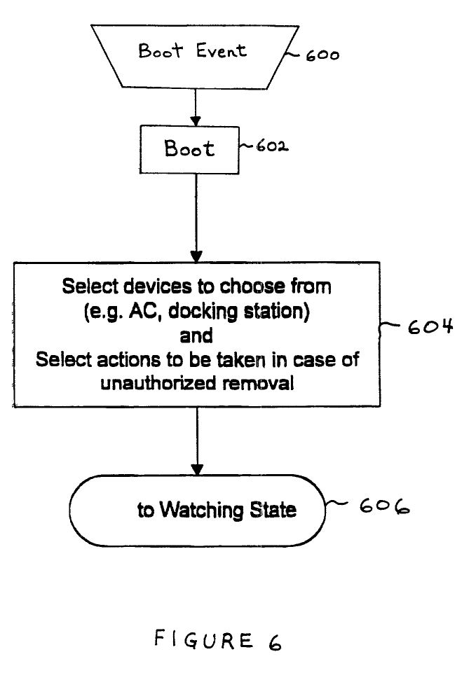

FIG. 5 is a state diagram of operation of computer 102 in securing system 100. The operation begins at a normal state 502. FIG. 6 is a flowchart of operation of computer 102 in normal state 502.

Initiating operation of system 100 may be called “booting” (or “rebooting”) system 100. Accordingly, in “booting” system 100, computer 102 copies portions of the OS software (e.g. Microsoft Windows) from a computer-readable medium (e.g. hard disk 111 or network 114) into memory 208, and computer 102 executes such portions. Moreover, in response to executing the OS software, computer 102 copies portions of application software from a computer-readable medium into memory 208, and computer 102 executes such portions.

A boot event may be, for example, user 112 “turning on” computer 102 (e.g. user 112 causing application of electrical power to computer 102 by switching an on/off button of computer 102). Alternatively, such a boot event may be receipt by computer 102 of a command to initially execute the OS software. For example, computer 102 may receive such a command from user 112 (e.g. through input devices 104), or from a computer application executed by computer 102, or from another computer (e.g. through network 114).

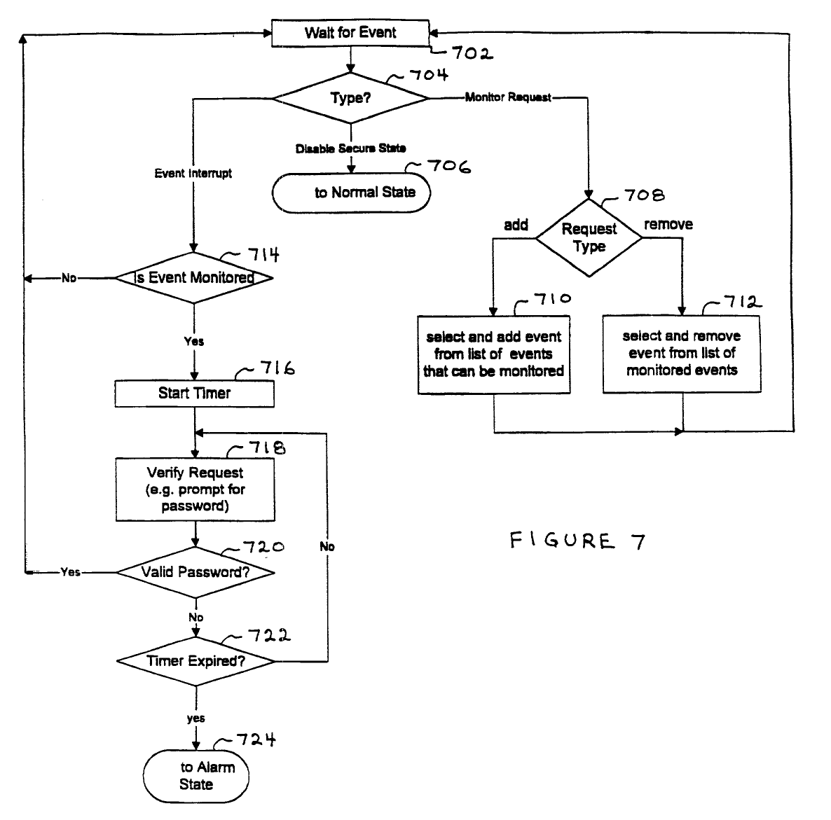

Referring simultaneously to FIG. 5 and FIG. 6, in response to a boot event 600 in normal state 502, computer 102 boots system 100 at a step 602, but only if BIOS 206 and I/O controller circuitry 204 enable normal booting of computer 102. When system 100 is initially manufactured, BIOS 206 and I/O controller circuitry 204 do enable normal booting of computer 102. However, after system 100 is initially manufactured, BIOS 206 and I/O controller circuitry 204 selectively disable normal booting of computer 102 as discussed further hereinbelow in connection with FIGS. 7 through 9.

After step 602, the operation continues to a step 604, where computer 102 initiates a security monitoring operation. In the illustrative embodiment, computer 102 performs step 604, but only in response to an “enable secure state” command that includes a predetermined valid password. For example, computer 102 may receive such a command from user 112 (e.g. through input devices 104), or from a computer application executed by computer 102, or from another computer (e.g. through network 114).

In performing step 604, computer 102 selects one or more (a) events to monitor for security purposes and (b) alarm actions to be performed by computer 102 in response to such events under circumstances discussed further hereinbelow in connection with FIGS. 7 through 9. In the illustrative embodiment computer 102 selects the events (and the alarm actions) in response to information (e.g. as specified by user 112) in the “enable secure state” command.

For example, computer 102 provides an option to select monitoring of an event in which system 100 becomes disconnected (or “detached”) from an object, such as: (a) disconnection of system 100 from power source 302 in a manner that removes AC power from power circuitry 216; or (b) disconnection of system 100 from docking station 402, irrespective of whether system 100 becomes disconnected from power source 302 in a manner that removes AC power from power circuitry 216. Such disconnection indicates a possible breach of security (e.g. theft of system 100), because such disconnection would normally be performed in the course of moving one or more components of system 100 to a substantially different physical location.

In the example of FIG. 3, system 100 may experience such disconnection and possible breach of security (a) if system 100 becomes disconnected from AC/DC converter 304, or (b) irrespective of whether system 100 remains connected to AC/DC converter 304, if AC/DC converter 304 becomes disconnected from power source 302. Similarly, in the example of FIG. 4, system 100 may experience such disconnection and possible breach of security (a) if system 100 becomes disconnected from docking station 402, or (b) irrespective of whether system 100 remains connected to docking station 402, if docking station 402 becomes disconnected from AC/DC converter 304, or (c) irrespective of whether system 100 remains connected to AC/DC converter 304 through docking station 402, if AC/DC converter 304 becomes disconnected from power source 302.

Computer 102 provides an option to select one or more of the following alarm actions to be performed by computer 102 in response to such events under circumstances discussed further hereinbelow in connection with FIGS. 7 through 9:

(a) display a predetermined visual image on display device 106;

(b) emit a loud noise through speakers of computer 102;

(c) in response to subsequent booting of computer 102, perform (a) and/or (b) above;

(d) prevent computer 102 from being “turned off” (e.g. disable an on/off button of computer 102, and disable the OS “shut down” feature), so that computer 102 expends (or “depletes”) all of its remaining battery power;

(e) automatically reset a valid password of computer 102, as for example by modifying information stored by BIOS 206, so that computer 102 subsequently boots only in response to an output of the reset valid password to computer 102 (e.g. by user 112 operating one of input devices 104); presumably, a thief would fail to know the reset valid password;

(f) disable subsequent booting of computer 102, as for example by modifying information stored by BIOS 206;

(g) after performing (e) above, perform (f) above in response to a predetermined number of attempts (e.g. by user 112) to subsequently boot computer 102 without successfully outputting the reset valid password to computer 102 (e.g. by user 112 operating one of input devices 104); and

(h) disable one or more functions of one or more other devices (e.g. input devices 104, display device 106) of system 100.

Accordingly, system 100 has a “secure” state during a period (“secure period”) between: (a) a first moment in which computer 102 processes an “enable secure state” command as discussed further hereinabove in connection with step 604; and (b) a second moment in which computer 102 processes a “disable secure state” command as discussed further hereinbelow in connection with FIG. 7. Notably, during the secure period in the illustrative embodiment, in response to an attempt (e.g. by user 112) to “turn off” computer 102 (e.g. by switching an on/off button of computer 102, or by initiating the OS “shut down” feature), computer 102 displays a predetermined visual image on display device 106. The visual image includes text that asks user 112 to operate one of input devices 104 in order to output a predetermined valid password to computer 102. Computer 102 disallows the “turn off” operation until the predetermined valid password is output to computer 102 (e.g. by user 112 operating one of input devices 104) in response to the visual image.

With continued reference to FIG. 5 and FIG. 6, after step 604, the operation continues to a watching state 504 at a step 606.

FIG. 7 is a flowchart of operation of computer 102 in watching state 504. Referring simultaneously to FIG. 5 and FIG. 7, in watching state 504, the operation begins at a step 702 where computer 102 waits for occurrence of an event. In response to computer 102 detecting an event at step 702, the operation continues to a step 704 where computer 102 determines the event's type. For example, the event at step 702 may be a “disable secure state” command or a “monitor request” command. Computer 102 may receive such a command from user 112 (e.g. through input devices 104), or from a computer application executed by computer 102, or from another computer (e.g. through network 114).

In response to the event at step 702 being a “disable secure state” command, the operation continues to normal state 502 at a step 706, but only if the “disable secure state” command includes a predetermined valid password.

Alternatively, in response to the event at step 702 being a “monitor request” command, the operation continues to a step 708 where computer 102 determines a “request type” of the “monitor request” command. In response to the “request type” being an “add” type, the operation continues to a step 710. Instead, in response to the “request type” being a “remove” type, the operation continues to a step 712.

At step 710, computer 102 selects and adds one or more events to monitor for security purposes, as specified in the “monitor request” command (but only if the “monitor request” command includes a predetermined valid password), in the same manner as discussed further hereinabove in connection with step 604 of FIG. 6. Conversely, at step 712, computer 102 selects and removes one or more events to monitor for security purposes, as specified in the “monitor request” command (but only if the “monitor request” command includes a predetermined valid password). After either step 710 or step 712, the operation returns to step 702.

In response to the event at step 702 being an event interrupt, the operation continues to a step 714. At step 714, computer 102 determines whether the event is a monitored event (as selected in steps 604, 710 or 712). In response to the event being other than a monitored event, the operation returns to step 702. Conversely, in response to the event being a monitored event (e.g. disconnection of system 100 from power source 302 in a manner that removes AC power from power circuitry 216), the operation continues to a step 716.

At step 716, computer 102 starts a timer to measure a predetermined length of time. After starting the timer at step 716, computer 102 prompts user 112 to verify the request (i.e. to confirm authorization of the event) at a step 718. In performing step 718 in the illustrative embodiment, computer 102 displays a predetermined visual image on display device 106. The visual image includes text that asks user 112 to operate one of input devices 104 in order to output a predetermined valid password to computer 102.

After step 718, the operation continues to a step 720 where computer 102 determines whether the predetermined valid password has been output to computer 102 (e.g. by user 112 operating one of input devices 104) after the event at step 702. In response to the predetermined valid password being output to computer 102 after the event at step 702, the operation returns to step 702. Conversely, in response to the predetermined valid password not being output to computer 102 after the event at step 702, the operation continues to a step 722.

At step 722, computer 102 determines whether the timer has expired (i.e. whether the predetermined length of time has elapsed). If the timer has not expired, the operation returns to step 718. Conversely, in response to expiration of the timer, the operation continues to an alarm state 506 at a step 724.

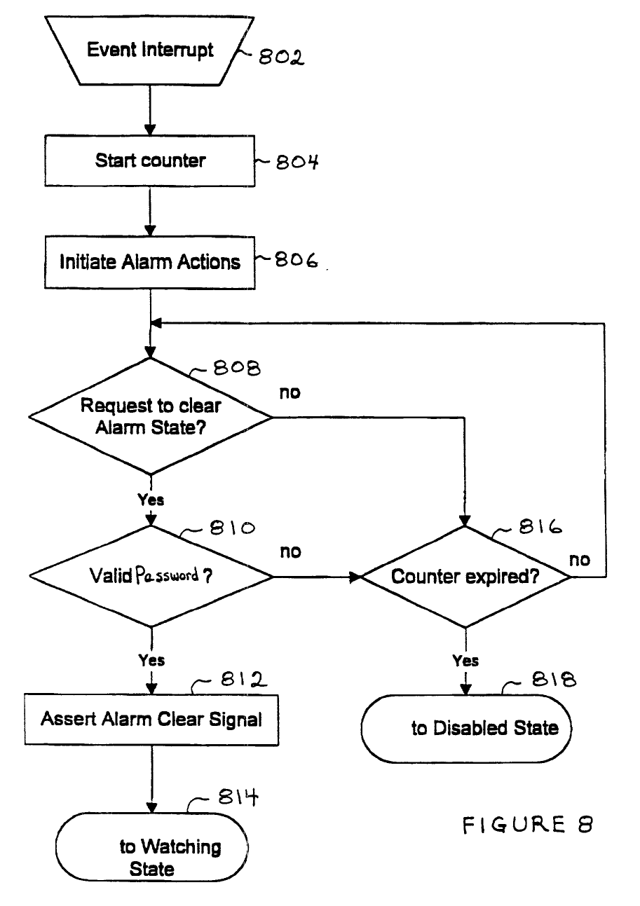

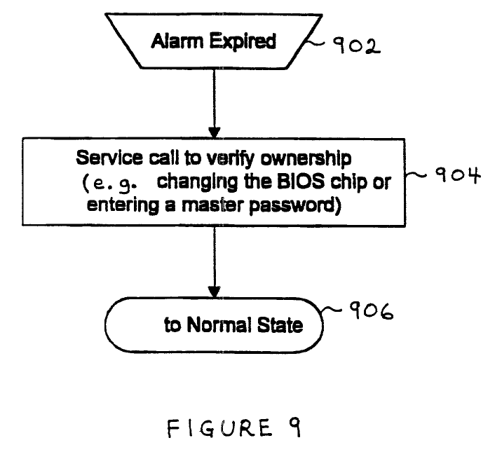

FIG. 8 is a flowchart of operation of computer 102 in alarm state 506. Referring simultaneously to FIG. 5 and FIG. 8, in response to event interrupt 802 (which was previously discussed hereinabove in connection with step 702 of FIG. 7) in alarm state 506, computer 102 starts a counter at a step 804 in order to measure a predetermined length of time.

After starting the counter at step 804, computer 102 initiates the alarm actions (as selected in step 604) at a step 806. After step 806, the operation continues to a step 808. At step 808, computer 102 determines whether cessation (or “clearance”) of the alarm actions (i.e. to request an end to the alarm state) has been requested (e.g. by user 112 operating one of input devices 104). In response to such a request, the operation continues to a step 810.

At step 810, computer 102 determines whether a predetermined valid password has been output to computer 102 (e.g. by user 112 operating one of input devices 104). In response to the predetermined valid password being output to computer 102, the operation continues to a step 812. At step 812, computer 102 ceases the alarm actions and asserts an alarm clear signal in order to end the alarm state. After step 812, the operation continues to watching state 504 at a step 814.

In response to a failure to request cessation of the alarm actions at step 808, or in response to the predetermined valid password not being output to computer 102 at step 810, the operation continues to a step 816. At step 816, computer 102 determines whether the counter has expired (i.e. whether the predetermined length of time has elapsed). If the counter has not expired, the operation returns to step 808. Conversely, in response to expiration of the counter, computer 102 generates an “alarm expired” signal, and the operation continues to a disabled state 508 at a step 818.

FIG. 9 is a flowchart of operation of computer 102 in disabled state 508. Referring simultaneously to FIG. 5 and FIG. 9, in response to “alarm expired” signal 902 (which was previously discussed hereinabove in connection with step 816 of FIG. 8), the operation continues to a step 904. At step 904, computer 102 displays a predetermined visual image on display device 106. The visual image includes text that notifies user 112 about the types of alarm actions (as selected in step 604) that computer 102 initiated at step 806.

Preferably, the alarm actions (as selected in step 604) include:

(a) automatically reset a valid password of computer 102, as for example by modifying information stored by BIOS 206, so that computer 102 subsequently boots only in response to an output of the reset valid password to computer 102 (e.g. by user 112 operating one of input devices 104); presumably, a thief would fail to know the reset valid password; and

(b) disable subsequent booting of computer 102, as for example by modifying information stored by BIOS 206.

In that manner, after computer 102 generates the “alarm expired” signal at step 818, BIOS 206 and I/O controller circuitry 204 disable normal booting of computer 102. Accordingly, in such a situation, user 112 (or a thief of computer 102) would be compelled to contact a manufacture of computer 102 for technical support in order to effectively use computer 102.

Before providing such technical support, the manufacturer may determine whether user 112 is authorized to have possession of computer 102. According to the types of alarm actions (as selected in step 604), the technical support may include (a) replacement of BIOS 206 (e.g. replacement of a BIOS EEPROM chip) or (b) provision to user 112 of a master password for output to computer 102.

After step 904, the operation continues to normal state 502 at a step 906.

Advantageously, in the illustrative embodiment, physical theft (e.g. away from power source 302) of system 100 is discouraged, because BIOS 206 and I/O controller circuitry 204 disable normal booting and/or normal operation of computer 102 in response to such theft. Accordingly, security of system 100 is less dependent on mechanical security features. Also, the security features of system 100 are less expensive and more conveniently useful than conventional mechanical security features.

According to a first alternative embodiment, user 112 operates a biometric device (of input devices 104) in order to output a valid password to computer 102. Such a biometric device optically scans and digitizes a fingerprint of user 112 in order to determine whether it matches a previously digitized fingerprint that is stored by system 100. In response to such a match, computer 102 determines that a valid password has been output to computer 102.

According to a second alternative embodiment, user 112 operates a card device (e.g. “smart” card device of input devices 104) in order to output a valid password to computer 102. In one example, user 112 operates such a card device by inserting a physical security token (e.g. “smart” card) into the card device. Such a card device reads digital information from the physical security token in order to determine whether it matches digital information that is stored by system 100. In response to such a match, computer 102 determines that a valid password has been output to computer 102.

Although illustrative embodiments have been shown and described, a wide range of modification, change and substitution is contemplated in the foregoing disclosure and, in some instances, some features of the embodiments may be employed without a corresponding use of other features. Accordingly, it is appropriate that the appended claims be construed broadly and in a manner consistent with the scope of the embodiments disclosed herein.

What is claimed is:

1. A computer system, comprising:
circuitry for:
detecting whether the computer system becomes disconnected from an object;
in response to the computer system becoming disconnected from the object, determining whether the disconnection is authorized; and
in response to the disconnection being unauthorized, initiating an alarm action.

2. The computer system of claim 1 wherein the object is a power source.

3. The computer system of claim 2 wherein the power source is an alternating current (“AC”) power source.

4. The computer system of claim 1 wherein the object is a docking station.

5. The computer system of claim 1 wherein the circuitry determines whether the disconnection is authorized by determining whether a valid password has been output to the computer system.

6. The computer system of claim 5 wherein the circuitry determines whether the disconnection is authorized by determining whether the valid password has been output to the computer system within a predetermined length of time after the computer system becomes disconnected from the object.

7. The computer system of claim 1 wherein the computer system includes a display device, and wherein the alarm action includes displaying a predetermined visual image on the display device.

8. The computer system of claim 1 wherein the computer system includes a speaker, and wherein the alarm action includes emitting a loud noise through the speaker.

9. The computer system of claim 1 wherein the computer system includes a battery for providing battery power to the computer system, and wherein the alarm action includes preventing the computer system from being turned off, so that the computer system expends all of its remaining battery power.

10. The computer system of claim 1 wherein the alarm action includes automatically resetting a valid password of the computer system.

11. The computer system of claim 1 wherein the alarm action includes disabling subsequent booting of the computer system.

12. The computer system of claim 1 wherein the alarm action includes disabling at least one function of at least one device of the computer system.

13. The computer system of claim 1 wherein the circuitry is for selecting one or more events in which the computer system is disconnectable from the object.

14. The computer system of claim 13 wherein the circuitry performs the selecting in response to a command from a human user.

15. The computer system of claim 13 wherein the circuitry performs the detecting by detecting whether the computer system becomes disconnected from the object by one of the selected events.

16. The computer system of claim 1 wherein the circuitry is for selecting the alarm action.

17. The computer system of claim 16 wherein the circuitry performs the selecting in response to a command from a human user.

18. The computer system of claim 16 wherein the circuitry performs the initiating by initiating the selected alarm action.

19. A computer system, comprising:
circuitry for:
detecting whether the computer system becomes disconnected from an alternating current (“AC”) power source;
in response to the computer system becoming disconnected from the object, determining whether the disconnection is authorized by determining whether a valid password has been output to the computer system; and
in response to the disconnection being unauthorized, initiating an alarm action.

20. The computer system of claim 19 wherein the alarm action includes automatically resetting a valid password of the computer system.

21. The computer system of claim 19 wherein the alarm action includes disabling subsequent booting of the computer system.

22. The computer system of claim 19 wherein the circuitry is for selecting, in response to a command from a human user, one or more events in which the computer system is disconnectable from the object.

23. The computer system of claim 22 wherein the circuitry performs the detecting by detecting whether the computer system becomes disconnected from the object by one of the selected events.

24. The computer system of claim 19 wherein the circuitry is for selecting, in response to a command from a human user, the alarm action.

25. The computer system of claim 24 wherein the circuitry performs the initiating by initiating the selected alarm action.

26. A computer program product, comprising:
a computer program processable by a computer system for causing the computer system to:
detect whether the computer system becomes disconnected from an object;
in response to the computer system becoming disconnected from the object, determine whether the disconnection is authorized; and
in response to the disconnection being unauthorized, initiate an alarm action; and
apparatus from which the computer program is accessible by the computer system.

27. The computer program product of claim 26 wherein the object is a power source.

28. The computer program product of claim 27 wherein the power source is an alternating current (“AC”) power source.

29. The computer program product of claim 26 wherein the object is a docking station.

30. The computer program product of claim 26 wherein the computer program is processable by the computer system for causing the computer system to determine whether the disconnection is authorized by determining whether a valid password has been output to the computer system.

31. The computer program product of claim 30 wherein the computer program is processable by the computer system for causing the computer system to determine whether the disconnection is authorized by determining whether the valid password has been output to the computer system within a predetermined length of time after the computer system becomes disconnected from the object.

32. The computer program product of claim 26 wherein the alarm action includes displaying a predetermined visual image on a display device of the computer system.

33. The computer program product of claim 26 wherein the alarm action includes emitting a loud noise through a speaker of the computer system.

34. The computer program product of claim 26 wherein the alarm action includes preventing the computer system from being turned off, so that the computer system expends all of its remaining battery power.

35. The computer program product of claim 26 wherein the alarm action includes automatically resetting a valid password of the computer system.

36. The computer program product of claim 26 wherein the alarm action includes disabling subsequent booting of the computer system.

37. The computer program product of claim 26 wherein the alarm action includes disabling at least one function of at least one device of the computer system.

38. The computer program product of claim 26 wherein the computer program is processable by the computer system for causing the computer system to select one or more events in which the computer system is disconnectable from the object.

39. The computer program product of claim 38 wherein the computer program is processable by the computer system for causing the computer system to select the one or more events in response to a command from a human user.

40. The computer program product of claim 38 wherein the computer program is processable by the computer system for causing the computer system to detect whether the computer system becomes disconnected from the object by one of the selected events.

41. The computer program product of claim 26 wherein the computer program is processable by the computer system for causing the computer system to select the alarm action.

42. The computer program product of claim 41 wherein the computer program is processable by the computer system for causing the computer system to select the alarm action in response to a command from a human user.

43. The computer program product of claim 41 wherein the computer program is processable by the computer system for causing the computer system to initiate the alarm action by initiating the selected alarm action

44. A method performed by a computer system, the method comprising the steps of:
connecting the computer system to an object;
detecting whether the computer system becomes disconnected from the object;
in response to the computer system becoming disconnected from the object, determining whether the disconnection is authorized; and
in response to the disconnection being unauthorized, initiating an alarm action.

45. The method of claim 44 wherein the step of detecting comprises:
detecting whether the computer system becomes disconnected from an alternating current (“AC”) power source.

46. The method of claim 44 wherein the step of initiating comprises:
initiating the alarm action in which a valid password of the computer system is automatically reset.

47. The method of claim 44 wherein the step of initiating comprises:
initiating the alarm action in which subsequent booting of the computer system is disabled.

48. The method of claim 44 further comprising the step of:
in response to a command from a human user, selecting one or more events in which the computer system is disconnectable from the object.

49. The method of claim 48 wherein the step of detecting comprises:
detecting whether the computer system becomes disconnected from the object by one of the selected events.

50. The method of claim 44 further comprising the step of:
in response to a command from a human user, selecting the alarm action.

51. The method of claim 50 wherein the step of initiating comprises:
in response to the disconnection being unauthorized, initiating the selected alarm action.
